(19) United States
(12) Patent Application Publication
(10) Pub. No.: US 2015/0332396 A1
(43) Pub. Date: Nov. 19, 2015

(54) Options Trading Interface to Facilitate Improved Trading Decisions

(71) Applicants: Alok Khuntia, Downers Grive, IL (US); Michael Izhaky, Burr Ridge, IL (US)

(72) Inventors: Alok Khuntia, Downers Grive, IL (US); Michael Izhaky, Burr Ridge, IL (US)

(21) Appl. No.: 14/716,812

(22) Filed: May 19, 2015

Related U.S. Application Data
(60) Provisional application No. 62/000,502, filed on May 19, 2014.

(51) Int. Cl. G06Q 40/04

(52) U.S. Cl. CPC G06Q 40/04

(57) ABSTRACT

The present invention relates to a software application that aggregates real-time market data in conjunction with novel real-time calculated analytics and represents the data and results in both dynamic graphical and numerical form. The real-time market data is graphically displayed in the form of banners, tiles, rows, and grid allowing for option traders to efficiently and effectively identify potential risk and trading opportunities.

### RELATED APPLICATION

This application claims priority to U.S. Provisional Patent Application 62/000,502 filed on May 19, 2014, entitled “Options Trading Interface to Facilitate Improved Trading Decisions”, the entirety of which is incorporated herein.

### BACKGROUND OF THE INVENTION

### Field of the Invention

The present invention relates generally to financial data analysis and presentation. More specifically, the invention relates to a system, method and software application that aggregates real-time market data in conjunction with processing novel real-time calculated analytics and represents the data and calculated analytics in both dynamic graphical and numerical form.

### SUMMARY OF THE INVENTION

This summary of the invention is provided to introduce concepts in a simplified form that are further described in the detailed description of the invention. This summary is not intended to identify key or essential inventive concepts of the claimed subject.

The present invention provides a system and method for displaying option and option trading data within an option chain in a clear, concise, and informative manner so that option traders can identify potential risk and trading opportunities more efficiently and effectively. The computerized system of the present invention aggregates real-time market data in conjunction with processing novel real-time calculated analytics. The data and analytics are then represented or displayed in both dynamic graphical and numerical form. Specifically, the system visually displays this data and analytic determinations in the form of banners, tiles, rows, graphs and grids some of which are generated by real-time calculated analytics.

A primary feature of the present invention is the illustration of a graphical user interface summary banner which is a graphical representation of summarized metrics for the expiry including market data and information about the user's current holdings in the expiry. In the preferred embodiment of the present invention, the banner graphically depicts option volatility change, volatility curve, relative options volume, portfolio exposure per expiration per underlyer of optionable securities. The banner utilizes color, size, and location of elements within the banner to communicate useful information to users allowing them to easily and quickly consume the data so they can make better informed trading decisions.

Residing in close proximity to the banner on the graphical user interface are tiles which are unlabeled cells that represent the key market values regarding the option expiry that are deemed most essential to option traders. The cells are distinguished by color and cell size to infer relative importance and to indicate substantial changes to the market values.

Another aspect of the present invention is that the system allows users to initiate transactions through a variety of ergonomically efficient user, mouse, or keyboard gestures. By placing the mouse (or finger or touch pen for touch screen devices) over specific locations on the banner or graphical user interface, the user can initiate an order for a strike, initiate a trade on one strike (open, close, hedge, unhedged), initiate a trade over multiple strikes (open, close, hedge, unhedged), initiate a trade over multiple expirations or strikes (open, close, hedge, unhedged), launch a spread or options calculator, launch a time and sales visualizer, or launch charting tools.

The system of the present invention is ideally suited for grouping or bucketing options and displaying those in a graphical interface with various metrics useful to determine implied volatility change per bucket and relative market volume per bucket. The system is useful for overlaying metrics about the user's portfolio on the delta bucketed graphic and creating or displaying a visual representation of market activity. The user interface uses color and size for various indicators. The red and green dots represent positions the user has in that stock (options) and the intensity of the color is used as well.

Further, the interactive or clickable graphic user interface (“GUI”) allows the user to trigger or initiate a process to complete simple or complex options orders. The system is also adept and providing users one or more graphical features to indicate a tight market (i.e. an indicator) as well as provide summarized information about option expiration in tile form. The system makes use of various proprietary metrics determined or calculated from data which include the tight market indicator (purple tile and pink and purple mini bars in the user interface); traded vega ratio which is displayed individually in a tile and also used to determine the color intensity (i.e. blueness) of the volatility change bars; the average daily vega which is used to describe the market activity in vega terms so the user can reasonably estimate the liquidity of the options market in that underlyer.

The present invention also provides a system and methods for displaying a graphical representation of options market information on a graphical user interface, the system comprising: at least one processor configured to receive and process real-time financial stock data including options contract data; where the options contract data for a selected stock are grouped according to expiry; the processor determines one or more option contract information points and calculates at least one option contract analytics value; and displaying a graphical user interface having a banner graph section, wherein the banner graph section includes at least one illustrative graph feature from the group consisting of (i) a bar graph height representing volatility change; (ii) a bar graph color saturation level representing relative volume; (iii) a tight markets indicator; (iv) an indicator representing an option contracts position; and (vi) a volatility curve.

The system and methods can also determine that at least one of the options contract analytics value is from the group consisting of: (a) an average volatility spread; (b) a time weighted traded vega ratio; (c) the current vega traded volume; (d) the average traded vega volume; (e) the implied volatility change; (f) a tight market indicator; and (g) a fit curve. The analytics value can be displayed on the user interface and the interface can also be displayed on a remote computer system such as a laptop. The GUI can also be used to initiate a trade transaction.

These and other objects, features, and/or advantages may accrue from various aspects of embodiments of the present invention, as described in more detail below.

### BRIEF DESCRIPTION OF THE DRAWINGS

Various exemplary embodiments of this invention will be described in detail, wherein like reference numerals refer to identical or similar components or steps, with reference to the following figures, wherein:

FIG. 1 illustrates an exemplary embodiment of system architecture of the present invention on which various embodiments of the inventive methodology may be deployed.

FIG. 2 illustrates a block layout of an exemplary user interface showing the major sections of the present invention.

FIG. 3 illustrates an exemplary option trading graphical user interface option in accordance with one or more embodiments of the inventive concept.

FIG. 4 illustrates an exemplary graphical user interface of the banner and tiles of the option trading interface in accordance with one or more embodiments of the inventive concept.

### DETAILED DESCRIPTION OF EXEMPLARY EMBODIMENTS

Particular embodiments of the present invention will now be described in greater detail with reference to the figures.

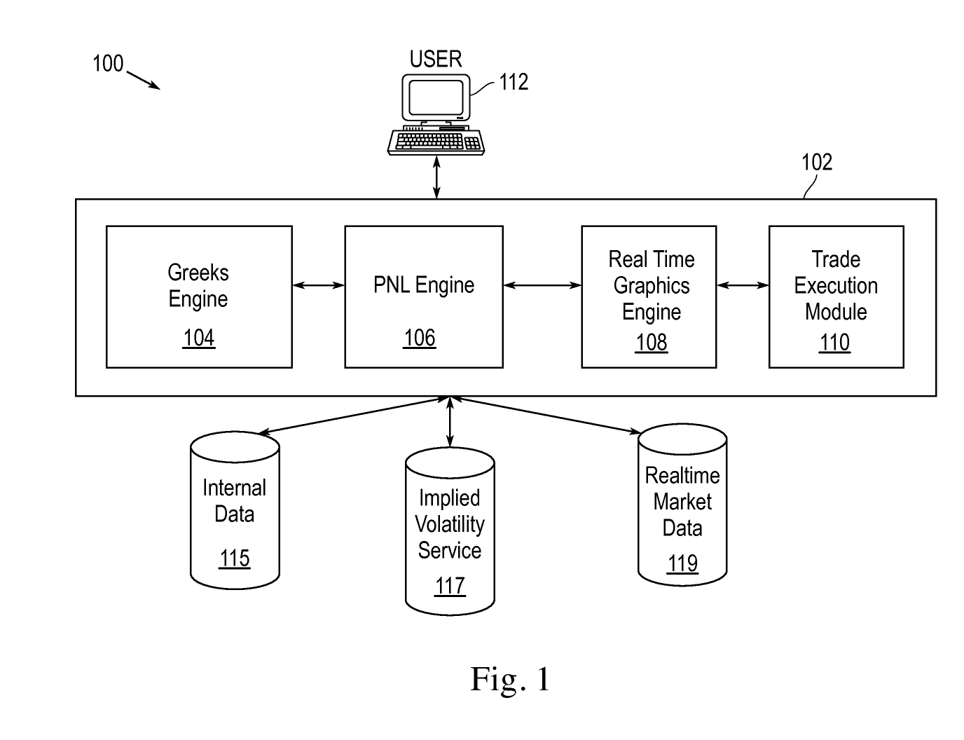

As shown in FIG. 1, the present invention provides for a system 100 which comprises one or more server platforms 102 on which various software applications, instructions or modules reside. The applications may include a Greeks engine 104, a PnL engine 106, a graphics engine 108, a trade execution module 110, and other applications such as a web server or data processing modules or code. The one or more processor based computers or server platforms 102 are connected to both short term or non-transitory dynamic memory and disc or long term memory. The system may be connected to one or more databases or data feeds. The databases or feeds may include internal data 115, implied volatility data or service 117, and real time market data or feed 119. The real time market data or feed 119 enables the servers 102 to receive real time (stock) option data via streaming data feeds from one or more third party (stock) option data services.

The databases and feeds 115, 117, 119 may be deployed or mirrored locally or accessed remotely using a network interface of the server system 102. The various applications, software, and programs 104, 106, 108, 110 may reside locally on the one or more servers 102 or connected through some secondary device such as through a LAN or WAN network, through some remote or internet based network, or some combination thereof. The user 112 may access system 100 and access to the applications or user interface through the Internet, local area network, wide area network, or telecommunication network.

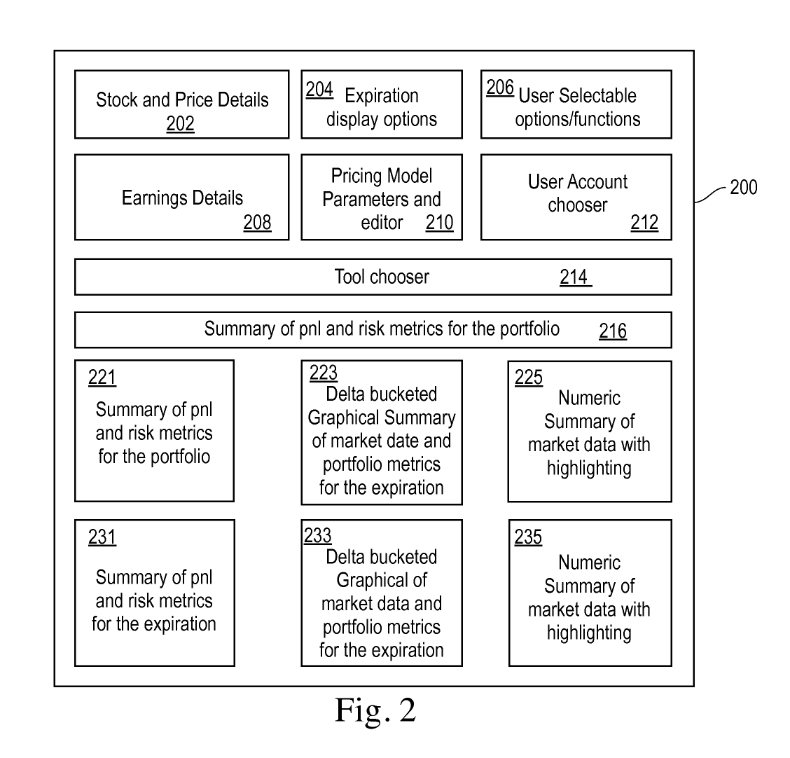

FIG. 2 provides an illustrative example of a graphical user interface 200 for an option contract trading information system. The graphical user interface 200 includes various sections on the interface including a stock and price details section 202, an expiration display options section 204, a user selectable options and functions 206, an earnings details section 208, a pricing model parameters and editor section 210, a user account section 212, a tool choice section 214, a portfolio summary of PnL and risk metrics section 216, an expiration summary of PnL and risk metrics section 221, a delta bucket graphical summary of market data and portfolio metrics section 223, and a numeric summary of market data with highlights section 225. The sections 202, 204, 206, 208, 210, 212, 214, 216, 221, 223, and 225 on the illustrative interface 200 can be placed in any logical layout to fit the format desired by the user. Additional rows of the summary of PnL risk metrics 231, Delta bucketed graphical aspects 232, and numeric summary 235 can be added at the user's discretion.

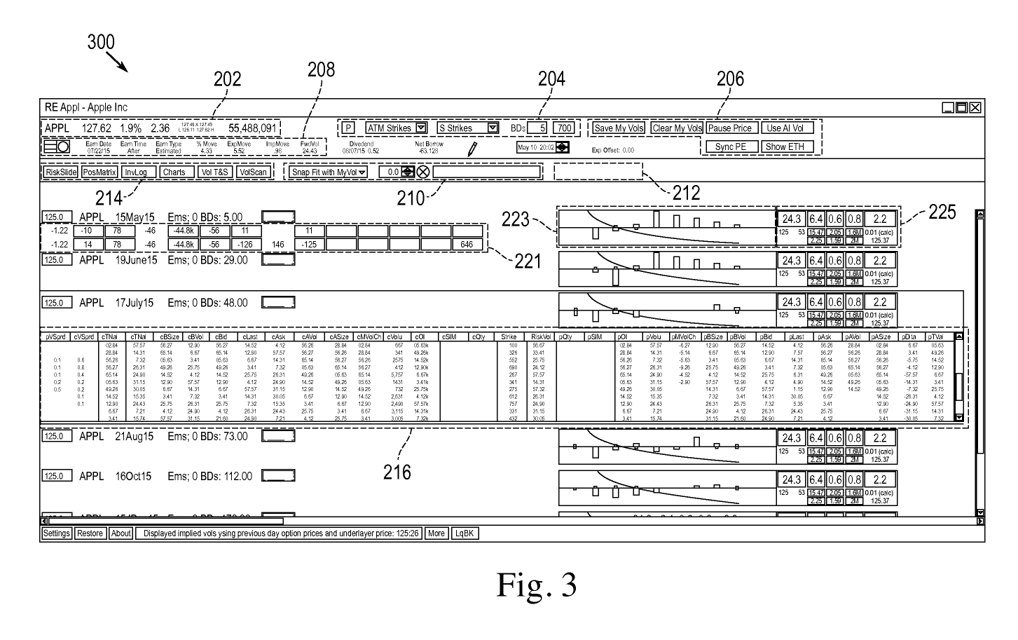

FIG. 3 illustrates a screen capture of a graphical user interface 300 with the sections 202-225 in a logical layout. The options trading interface 300 contains pertinent option chain information for a stock symbol organized into several sections that are represented in both dynamic graphical and numerical form. For our illustrative example, the option chain information is for Apple Inc. (APPL). The stock and price details are displayed in section 202. The expiration display options can be selected by the user in section 204 and may include items such as ATM strikes and Number of days until expiration. User selectable options and functions are shown in section 206 which include saving user volatilities, clearing user volatilities, pausing price, using Average Implied (“AI”) Volatility, sync inputs with server and show extended hour pricing (“ETH”). Earnings details for the option contracts displayed are shown in section 208 while section 210 shows a pricing model. The user account section 212 provides access to various user specific accounts. The user may also be provided various tools as seen in section 214 such as RiskSlide, PosMatrix, InventoryLog, and Charts.

The interface 300 also may contain a summary of PnL and risk metrics for the user's portfolio of options in section 216. In the preferred embodiment, the option contract expiries are organized in chronological order given the filters for business date range. The user can customize the arrangement of the option contract expires in order to construct different views such as a time spread view which would arrange expiries according to a user defined time spread.

Within this section 216, each expiry contains an expiry banner, tiles, and a data grid. These elements of the option contract expiries may be immediately visible or only visible upon an action caused by the user. In the preferred embodiment of the present invention, the user may click the grey button to the left of the expiration date, to cause the expiry to expand and cause its data grid to become visible.

The user may select to have one or many options chain (grid) consisting of one row per strike per expiration with multiple user selectable columns. The data grid for a single expiration contains real-time data and real-time metrics typically represented in an option chain. The strikes in an expiry are listed on the y-Axis and a variety of data fields are listed on the x-axis. In the preferred embodiment of the present invention, the data grid will include a myriad of data fields which the user can select from standard options data fields. Many of the columns in the data grid employ complex conditional formatting to highlight values that are of likely interest to the trader.

The columns of section 216 may include Vega, Theta, Gamma, Delta, Rho, $Delta, wvga%, $deltaDecay, Shares, open, Day, Net, Puts, Calls, TheoEdge, PoP, pVega, pGamma, pDelta, pTheta, pCapture, and SD Gamma. These values may be calculated on the system server 102 and transmitted to the user (see FIG. 1) and displayed accordingly on the user's device 112. Based on these calculations and data analysis, the information or the cells with the information are displayed or may be displayed in a certain color, size, format (i.e. bold) or font.

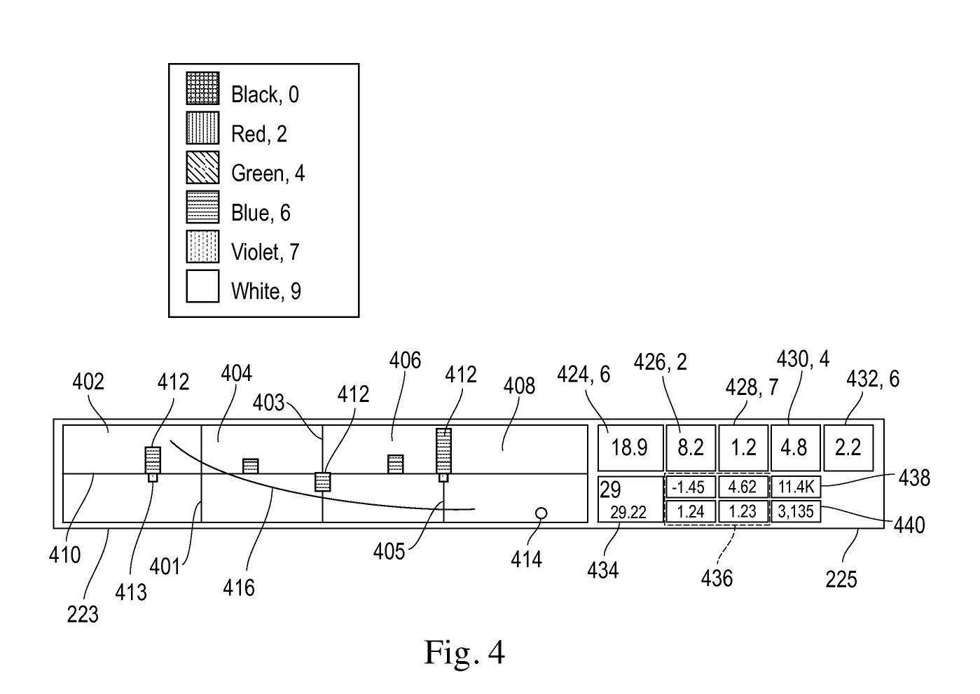

The interface 300 also includes the summary of PnL and risk metrics for the expiration in section 221. An important aspect of the present invention is the delta bucketed graphical summary of market data and portfolio metrics for the expiration which is depicted in section 223 and further detailed in FIG. 4. Finally, a numeric summary of market data with highlights is displayed in section 225.

Further, the rows and cells of the interface 300 are interactive and can be customized according to the user's preferences. By interacting with the cells, information within the cells and choosing the metric in which the user wants to see graphically represented, the system will automatically update the other information and sections to conform to the user's preferences. By way of example, if the user wants to see the Rho metric visually displayed in the banner and tiles, he or she may use her mouse to guide the mouse cursor over the Rho cell within the Server risk calculations row and click it. Once this occurs, the cell will become highlighted and the server will automatically update the expiry banners and tiles accordingly. Further, by clicking on one or more cells in the grid, the user can initiate multiple actions including the initiation of trades or the display of additional data.

FIG. 4 illustrates an exemplary banner and tiles of the option trading interface in accordance with one or more embodiments of the inventive concept. The banner consists of the delta bucketed graphical summary 223 and the tiles are within the numeric summary of market data with highlights section 225.

The banners are a graphical depiction of summarized real-time metrics for the expiry including market data and information about the user's current holdings in the expiry. The banners are interactive and can be manipulated or customized by the user to change the metrics being displayed. In the preferred embodiment, a user can interact with the banners by clicking on a desired location within the banner itself or selecting one or more cells within the service risk calculations row and the client risk calculations row. When one banner is manipulated, the banners of each expiry are also automatically adjusted accordingly allowing the trader to compare one expiry banner to another and get a feel for relative movement.

The banner contains one or more dotted vertical lines called delta bucket guidelines 401. In the preferred embodiment, the banner contains three dotted vertical lines 401, 402, 403. These delta bucket guidelines 401, 402, 403 are displayed to help the trader identify the different delta buckets represented in the delta bucket regions 402, 404, 406, 408. Delta buckets are determined or defined by a grouping of options within defined ranges. In the preferred embodiment, the x-axis is the horizon or neutral line 410. The options 412 within the bucket or grouping will be displayed as falling above or below the horizon. The x-axis may be divided into numerous segments and, in the preferred embodiment, is divided into 11 segments corresponding to the 11 delta buckets. The 11 delta buckets are: 100-90, 90-80, 80-70, 70-60, 60-52.5, 52.5-47.5, 47.5-40, 40-30, 30-20, 20-10, and 10-0. For easy identification, the delta buckets may be accentuated with a vertical dotted line.

Within the banner 223, several metrics are summarized and visually depicted that assist option traders in their trading decisions. In the preferred embodiment, the banner 223 visually depicts summarized metrics such as option volatility change, volatility curve, relative options volume, portfolio exposure per expiration per underlyer of optionable securities. These summarized metrics may be visually depicted by a variety of shapes, lines, colors, sizes, locations, and the like. In the preferred embodiment, these summarized metrics are visually represented by bars, dots, and curves that range from different colors, sizes, and locations within the banner.

A colored bar may 412 be used to show the volatility change and volume depiction of the delta bucket. A delta bucket contains all options that have a delta within the range of the delta bucket (i.e. 100-90, 90-80, 80-70 . . . ). The height, width, location, and color of the bar 412 denote several important pieces of information regarding an option metric. In the preferred embodiment, a volatility change bar 412 is colored shades of blue and is of a fixed width. When the strikes for a delta bucket are identified, an average of the volatility change and relative volume is calculated. The volatility change is depicted by the distance above or below the horizon 410 and helps depicts the implied volatility change of the options within the delta bucket being displayed. A tall bar above the neutral level 410 may mean that the market implied volatility of the options in the delta bucket are substantially higher now compared to those exact same options as of the prior business day's closing prices. The relative volume is depicted with or by the transparency or darkness of the shading or color of the bar 412. The scaling of the y-axis is the same for all banners and auto-sized based on the range of values. This allows the trader to compare one expiry banner to another and get a feel for relative movement.

In our exemplary embodiment, the purple/pink bars or tight market bars 413 are of fixed width and height and are used to identify delta buckets that contain “tight markets”. Tight markets are individual strikes where various algorithms have identified an unusually tight spread between bid and ask prices. The purple and pink tight market bars 413 are used to identify levels of tightness. The tight markets indicator is based on a novel calculation for ‘vega weighted average volatility spread’ which calculates the average spread between bid and ask in volatility units for the entire expiration in the expiry for the underlyer. The calculation weights the strikes with higher vega more than the strikes with lower vega. The ‘tight market’ indicator or bar 413 relies on the ratio of vega weighted width for an option and compares it to the average. When the ratio is less than a first level, a color is assigned, such as the color purple. When it is less than a second level, the color assigned may be pink.

The banner 223 may also contain visual depictions of information in the form of colored dots 414. In the preferred embodiment, these dots 414 are either red or green and represent the quantity of contracts or positions in the trader's portfolio in each delta bucket. In the preferred embodiment, a red or green dot 414 can be used to identify LONG and SHORT positions. The distance of the dot away from the x-axis horizon 410 is associated with the relative size of the position. The information represented within the dot may be customized by the user to represent another metric besides quantity. A user can change the actual metric represented by the dot by clicking on a cell within the server risk calculations row and the client risk calculations row.

The banner 223 also includes a volatility curve 416 that visually depicts the relationship of implied volatility and delta for each option in the options chain for the expiry. Implied volatility is calculated by generally accepted binomial options pricing models. The volatility curves 416 describe the relationship between strikes in implied volatility. The shape of the curves allows options traders to quickly identify the market sentiment for stock. The color of the volatility curve 416 has no specified meaning and can be customized by the user. In the preferred embodiment, the color of the curve 416 is green.

The system of the present invention also employs various unique mathematical algorithms and calculations. The system uses these algorithms to calculate or determine: (A) an average volatility spread; (B) a time weighted traded vega ratio; (C) the current vega traded volume; (D) the average traded vega volume; (E) the implied volatility change; (F) a tight market indicator; and (G) a fit curve.

The average volatility spread is an algorithm that evaluates the difference between bid and ask prices of all calls and puts in a given expiry for a given or selected stock. The value represents the average spread in terms of implied volatility points. The tile which displays the average volatility spread is color coded. The color is based on a separate algorithm that evaluates the options in the expiry to determine if there is a particular security (call or put in the expiry) that is substantially tighter than the expected average spread (is used with the tight market indicator).

The Time Weighted Traded Vega Ratio is a ratio representing the relative activity in a particular expiry. The system calculates the Average Traded Vega (D) over the past n days using a weighting process that gives more weight to those options that are more sensitive to implied volatility of the market prices. The system also calculates the current vega traded today (C) and then calculates the ratio C/D while taking into account the amount of time that has passed so far in the trading day and the typical profile of volume activity during the trading. The value B gives a real indication of how busy a stock is versus normal based on the time of the day.

The Current Vega Traded (C) is a calculation representing the current day's volume of options trade activity represented in the term ‘vega’ (change in price of an option for a change in implied volatility). The Average Traded Vega (D) is an average of prior days volume of options trade activity represented in the term ‘vega’ per day. The Implied Volatility (E) change per delta bucket is an average implied volatility change for options in the given delta bucket. The color of the bar is determined using value C and D for the options in the delta bucket.

The Tight Market indicator (F) is a graphical mark which indicates that there is a contract in the delta bucket that appears to be tighter than expected. It relies on item A. The Fit Curve (G) are values representing the ‘fit’ in a generally smooth curve which represents the shape of the implied volatilities for each option. The unique process helps the system to interpret or read market data, performs extensive filtering and calculations and then generates and displays a five (5) parameter Fit Curve.

As can be seen in section 225 (FIG. 4): (A) the average volatility spread is provided in cell 428; (B) the time weighted traded vega ratio can be seen in cell 430; (C) the current vega traded volume can be seen in cell 438; (D) the average traded vega volume can be seen in cell 44; (E) the implied volatility change 412; (F) a tight market indicator; 413 and (G) a fit curve parameters can be seen in section 436.

The system performs a massive number of calculations per minute which based on a typical high volume stock, like AAPL, has about 3000 options. The system performs optimizations to reduce the volume of calculations which need to be performed. However, even with the optimizations, the system calculates the various parameters for as many as 500 options. The system calculates dozens of values on every tick of the stock. The calculations are high iteration binomial pricing models. By way of scale, the number of calculations for implied volatility calculations in one (1) minute assuming 2 stock ticks per second (60 seconds*2 tick/sec*500 options*2 quotes (bid and ask)*50 iteration binomial mode) would equate to 6 million calculations in a minute.

The implied volume is used to calculate many other things (20 or more) for all options (60 seconds*2 ticks/sec*1500 options*20 metrics) yielding another 3.6 million calculations per minute. Although this is just a simplified example, the combined system calculates as many as 9.6 million calculations, or more, in a minute*6.5 hours=3.74 billion calculations during trading hours. However, the system continues to run outside of market hours. The current system processes a high volume of data and performs a high volume of transactions significantly beyond what a human could handle mentally.

The options trading interface of the present invention also includes the numeric summary of market data section 225 which displays essential information for each option contract expiry. In the preferred embodiment, the expiry tiles are unlabeled and located to the right of the expiry banner 223. The unlabeled tiles or cells contain individual graphical elements that represent the most important market values regarding the option expiry. The market values displayed within the tiles may be customized by the user to fit his or her preferences. In the preferred embodiment, the tiles include market values such as the at-the-money volatility, at-the-money volatility change; the average vega-weighted width for expiry strikes, traded vega ratio, at-the-money synthetic straddle, at-the-money strike and delta, volatility curve parameters for the expiry, average traded vega for the expiry, and reference forward price. An explanation of these preferred market value metrics and the way the system calculates them is described in further detail herein.

The tiles cells are distinguished by color and cell size to infer relative importance to the option trader when making options trading decisions. The first cell 424 contains the at-the-money implied volatility metric. The number displayed is a calculation of the average implied volatility of the single most relevant option for the trader by identifying the nearest at-the-money strike.

The second cell 426 contains the at-the-money volatility change on the day for the at-the-money option. The color of the cell changes according to how substantial the daily change has been. For example, if the volatility is up >=2%, the color is dark green, if it >5%, the color is bright green. The goal is to draw the trader's attention when there is a large up or down change in implied volatility. The third cell displays the average vega-weighted width for the strikes in the expiry. The coloring indicates if there are strikes that are substantially tighter than the average. These tighter markets are potentially more lucrative for the trader.

The fourth cell indicates the traded vega ratio. This number represents the time weighted relative activity of this expiry versus normal. The coloring indicates if this expiry is substantially more active than the average. The fifth cell is a calculation of the at-the-money synthetic straddle.

The tiles may also include cells in subsequent rows containing numerical representation of ATM strike and delta, the volatility curve parameters, traded vega for the expiry, average traded vega for the expiry, and the reference forward price. These cells are smaller in size due to the fact that they are less crucial to the user as they first look at the symbol.

In one or more embodiments of the invention, the user of the graphical interface can select one or more visually depicted elements within a banner to receive additional information about the options within the expiry. This can be accomplished by moving the user's mouse cursor to a desired location within the banner, clicking and holding the user's mouse button and dragging the cursor to another desired location forming a “selection-highlighting” rectangle. Once the user releases the mouse button, another window containing a data grid will appear providing the user with further information about the selected delta bucket(s).

The system also allows users to initiate transactions through a variety of ergonomically efficient mouse and keyboard gestures. In one embodiment of the present invention, a user can select elements of the banner, such as a bar, to initiate an order of one or more strikes. The transaction can include most common financial transactions including option ticket orders to buy or sell; equity ticket orders to buy or sell; and a spread ticket with a bid and ask.

In another embodiment of the present invention, the system may utilize artificial intelligence to predict and product potential trading opportunities the user may be interested in due to past trades made by the user.

Computing devices and systems, as used herein, may include one or more processors or processing units, one or more computer readable media which can include one or more memory and/or storage components, one or more input/output (I/O) devices, and a bus that allows the various components and devices to communicate with one another. Computer readable media and/or one or more I/O devices can be included as part of, or alternatively may be coupled to, computing device. The bus represents one or more of several types of bus structures, including a memory bus or memory controller, a peripheral bus, an accelerated graphics port, a processor or local bus, and so forth, using a variety of different bus architectures. Bus may include wired and/or wireless buses. Memory/storage component represents one or more computer storage media which may include volatile media (such as random access memory (RAM)) and/or nonvolatile media (such as read only memory (ROM), Flash memory, optical disks, magnetic disks, and so forth). Memory and/or storage may also include fixed media (e.g., RAM, ROM, a fixed hard drive, etc.) as well as removable media (e.g., a Flash memory drive, a removable hard drive, an optical disk, etc.).

The techniques discussed herein may be implemented in software, with instructions executed by one or more processing units. It is to be appreciated that different instructions can be stored in different components of computing device, such as in a processing unit, in various cache memories of a processing unit, in other cache memories of device, on other computer readable media, and so forth. Additionally, it is to be appreciated that the location where instructions are stored in computing device may change over time. Further, the one or more I/O devices allow a user to enter commands and information to the computing device, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media may be any available medium or media that can be accessed by a computing device. By way of example, and not limitation, computer readable media may comprise “computer storage media” and “communications media.”

“Computer storage media” include volatile and non-volatile, and removable and non-removable media implemented in any method or technology for storage of information such as computer readable instructions, data structures, program modules, or other data. Computer storage media include, but are not limited to, RAM, ROM, EEPROM, Flash memory or other memory technology, CD-ROM, digital versatile disks (DVD) or other optical storage, magnetic cassettes, magnetic tape, magnetic disk storage or other magnetic storage devices, and/or any other medium which can be used to store the desired information and which can be accessed by a computer.

“Communication media” typically embody computer readable instructions, data structures, program modules, or other data in a modulated data signal such as carrier wave or other transport mechanism. Communication media may also include any information delivery media. The term “modulated data signal” means a signal that has one or more of its characteristics set or changed in such a manner as to encode information in the signal. By way of example and not limitation, communication media include wired media, such as a wired network or direct-wired connection, and wireless media, such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry, system on a chip), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code may be stored in one or more computer readable memory devices. The features of the present disclosure described herein are platform-independent, meaning that the techniques may be implemented on a variety of commercial computing platforms having a variety of processors.

As will be apparent to one skilled in the relevant art(s) after reading the description herein, computing device may be configured as any number of computing devices such as a game console, a portable media player, a desktop, a laptop, a server, a notebook computer, a tablet computer, a PDA, a mobile computer, a smart telephone, a mobile telephone, an intelligent communications device or the like.

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects, but should be defined only in accordance with the following claims and their equivalents.

It will be recognized by those skilled in the art that changes or modifications may be made to the above described embodiment without departing from the broad inventive concepts of the invention. It is understood therefore that the invention is not limited to the particular embodiment which is described, but is intended to cover all modifications and changes within the scope and spirit of the invention.

1. A system for displaying a graphical representation of options market information on a graphical user interface, the system comprising:
a. at least one processor configured to receive and process real-time financial stock data including options contract data; wherein the options contract data for a selected stock are grouped according to expiry; wherein the processor determines one or more option contract information points and calculates at least one option contract analytics value;
b. displaying a graphical user interface having a banner graph section, wherein the banner graph section includes at least one illustrative graph feature from the group consisting of (i) a bar graph height representing volatility change; (ii) a bar graph color saturation level representing relative volume; (iii) a tight markets indicator; (iv) an indicator representing an option contracts position; and (vi) a volatility curve.

2. The system of claim 1, wherein the at least one option contract analytics value is from the group consisting of (a) an average volatility spread; (b) a time weighted traded vega ratio; (c) the current vega traded volume; (d) the average traded vega volume; (e) the implied volatility change; (f) a tight market indicator; and (g) a fit curve.

3. The system of claim 2, wherein at least one option contract analytics value is displayed.

4. The system of claim 1, wherein the interface can be displayed on a second processor remote from the at least one processor.

5. The system of claim 1, wherein the graphical user interface features can be used to initiate a trade transaction.

6. A method for displaying an option contracts graphical user interface to a user comprising:
a. receiving real time financial stock data including options contract data;
b. processing the real time financial data and grouping the options according to expiry;
c. calculating at least one option contract analytics value;
d. displaying a banner graph section on a graphical user interface, wherein the banner graph section includes at least one illustrative graph feature from the group consisting of: (i) a bar graph height representing volatility change; (ii) a bar graph color saturation level representing relative volume; (iii) a tight markets indicator; (iv) an indicator representing an option contracts position; and (vi) a volatility curve.

7. The method of claim 6, further comprising the steps of determining at least one option contract analytics value from the group consisting of: (i) an average volatility spread; (ii) a time weighted traded vega ratio; (iii) the current vega traded volume; (d) the average traded vega volume; (e) the implied volatility change; (f) a tight market indicator; and (g) a fit curve.

8. The method of claim 7, further comprising the step of displaying at least one option contract analytics value.

9. The method of claim 6, further comprising the step of transmitting and displaying the user interface on a second and remote processor.

10. The method of claim 6, further comprising the step of initiating a financial trade transaction, wherein the graphical user interface features can be used to initiate a trade transaction.
